(19) United States
(12) Patent Application Publication
(10) Pub. No.: US 2008/0296432 A1
(43) Pub. Date: Dec. 4, 2008

(54) METHOD OF EXTENDING LENGTH OF AIRCRAFT TO INCREASE INTERIOR SPACE

(75) Inventor: Willem J.A. Kernkamp, Sunland, CA (US)

Correspondence Address: STOEL RIVES LLP, 900 SW FIFTH AVENUE, SUITE 2600, PORTLAND, OR, 97204-1268, US

(73) Assignee: KERNKAMP INDUSTRIES CORPORATION, Chatsworth, CA (US)

(21) Appl. No.: 12/131,847

(22) Filed: Jun. 2, 2008

Related U.S. Application Data
(60) Provisional application No. 60/941,924, filed on Jun. 4, 2007.

(51) Int. Cl. B64C 1/30

(52) U.S. Cl. 244/120

(57) ABSTRACT

A method of modifying an aircraft, increasing its length, to increase interior of the aircraft fuselage to accommodate more passenger rows or more freight. The typical aircraft such as the Boeing 757 aircraft includes a fuselage, a wing section and a tail section, wherein the method installs an extension section or plug in the fuselage aft of the wing section and further adjusts the forward center of gravity limits aft.

### RELATED APPLICATION DATA

This application claims priority to provisional application No. 60/941,924 filed Jun. 4, 2007 hereby incorporated by reference.

### BACKGROUND

The field of the present disclosure relates to methods and designs for extension of existing aircraft to increase interior space. Previously, this extension has been accomplished by insertion of plugs within the aircraft fuselage. However, the present inventor has recognized that prior methods are inefficient, at least in part because they ignore the cost benefits of rebalancing the aircraft and controlling design loads described herein.

### BRIEF DESCRIPTION OF THE DRAWINGS

FIG. 1 is a schematic illustrating a conventional aircraft.

FIG. 2 is a schematic illustrating a modified aircraft according to a preferred embodiment and containing an extension plug.

FIG. 3 is a graph of the limits on the movement of the center of gravity allowed versus the weight of the aircraft.

### DETAILED DESCRIPTION

The present inventor has recognized that when modifying an existing aircraft by inserting plugs within the fuselage, one difficulty of maintaining airworthiness lies in the fact that the effects of the plug installation extend beyond the immediate insertion point. Typically, the fuselage design loads between the plug insertion point and the wing to body joint are significantly increased. This load increase requires the installer to: (1) minimize the affected structure by inserting the plug as close to the wing as possible; (2) perform extensive structural analysis; and (3) in most cases perform significant structural re-enforcement in addition to the plug installation itself. In addition to these difficulties, the lengthened fuselage changes the fuselage modal frequencies of the aircraft. This change in modal frequency has an effect on the flutter characteristics of the aircraft.

A preferred aircraft modification method may address one or more of the problems listed above by rebalancing the aircraft as follows:

(1) Installing the plug in the aft fuselage anywhere along the constant diameter section.

(2) Controlling critical design loads to remain within the design loads for the structure forward of the plug.

Prior to detailing these two steps further below, it should be pointed out that the steps go together. It is not possible or it is at least unreasonably impractical to control critical design loads for a forward fuselage plug, that is, no step 2 without step 1. Moreover, it is not feasible to install a plug at an arbitrary position along the aft fuselage without managing the critical design loads, that is no step 1 without step 2. The feasibility relates to the need for extensive analysis and re-enforcement as will be described further below.

### The Aft Fuselage Plug

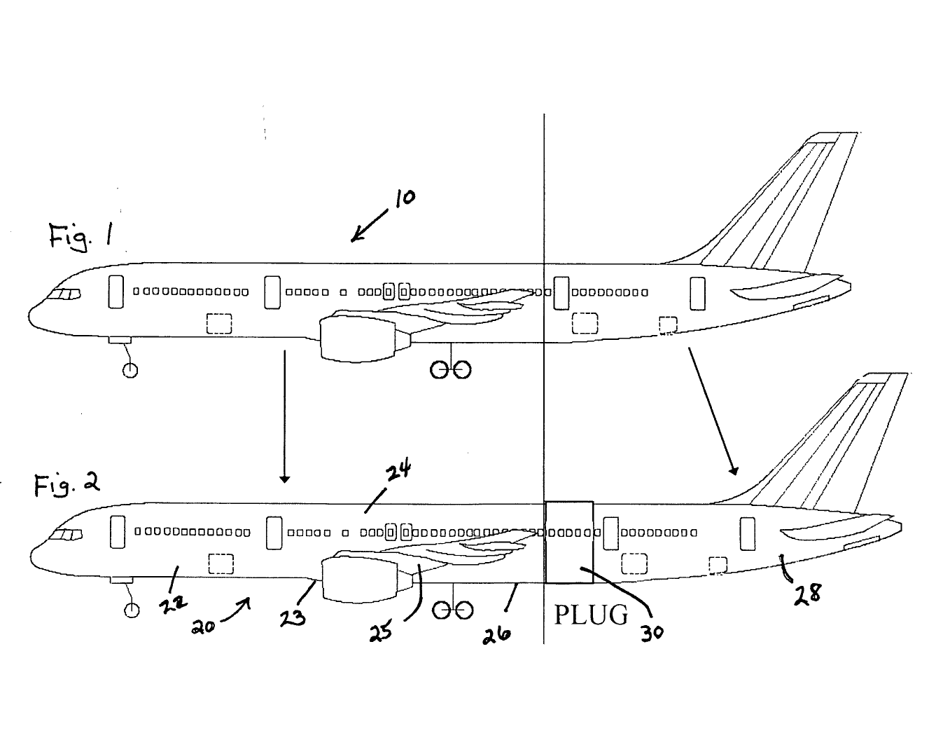

FIG. 1 illustrates a conventional aircraft 10 such as the Boeing 757 and FIG. 2 illustrates a Boeing 757 aircraft 20 that has been modified from the original structure of FIG. 1 according to a preferred embodiment. As shown in FIG. 2, the modified aircraft 20 includes a front section 22, a central or wing fuselage section 24, wings 25 (the right wing not being visible in the figure), an aft section 26, and a tail section 28. Typically the central section 24 of the fuselage proximate the wing 25 is reinforced in a region fore and aft. A slightly enlarged diameter section 23 just fore of the wing 25 is visible in the figure which is caused by a blended wing fairing. The aft section 26 of the aircraft 20 has been modified from its original form by the addition of the extension plug 30.

As shown in the drawing, the extension plug 30 is preferably disposed in the aft section 26 in a region of constant diameter prior to the reducing diameter at the transition to the tail section 28. This preference for positioning the extension plug 30 in the aft fuselage section 26 may be considered counter-intuitive for a number of reasons. First of all, the aft fuselage is considered to be more highly loaded than the forward fuselage due to the tail surfaces. In addition, the dynamic effects are also more significant, because of the aerodynamic interaction with those same tail surfaces. A third effect of an aft fuselage plug is that the center of gravity of the aircraft is moved aft. This effect applies both to an empty aircraft and to an aircraft with payload, because the payload space runs further aft. This effect has caused other aircraft designers to employ a symmetric pair of plugs, one for the aft fuselage and another balancing plug for the forward fuselage, which doubles the work. There is a good reason for not letting the center of gravity move aft, because the aircraft directional stability is reduced.

### The Center of Gravity Limits

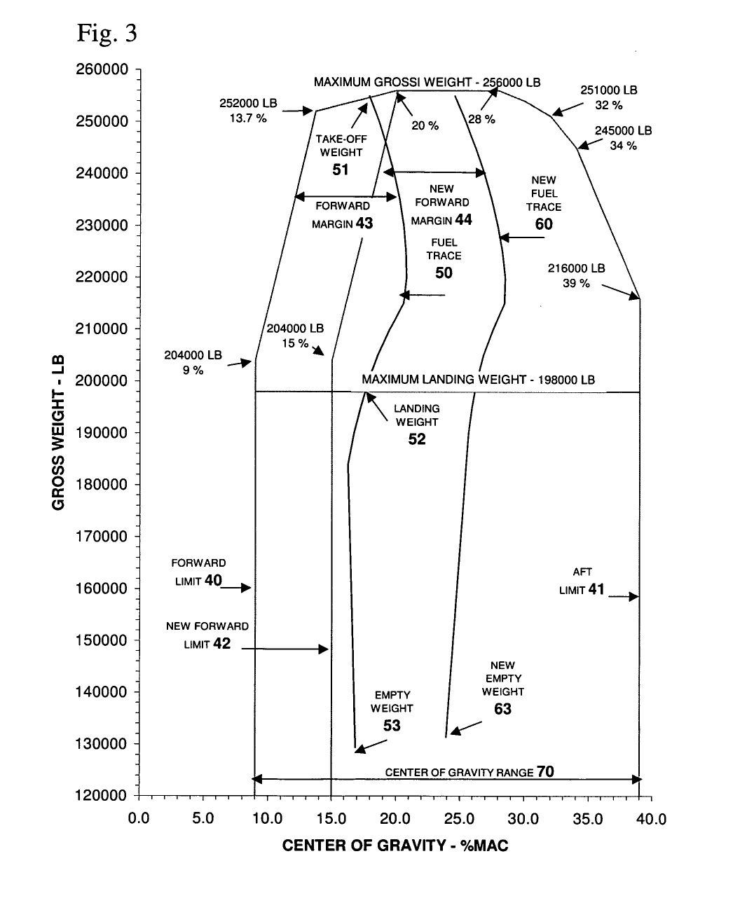

FIG. 3 illustrates an example center of gravity chart from an Aircraft Flight Manual. The chart illustrates two fuel burn traces super-imposed, one for an unmodified aircraft, and another for an aircraft modified according to a preferred embodiment. There are a forward limit 40 and an aft limit 41. The aircraft must be loaded with fuel and cargo in such a manner that the center of gravity will remain inside these limits throughout the flight. As the fuel is burned, the center of gravity follows the trace 50, from the takeoff position 51 to the landing position 52. When the payload is removed, the center of gravity for the empty weight 53 is reached. After installation of the aft fuselage plug, the modified aircraft assumes a new fuel trace 60 that runs aft of the original trace. The new empty weight 63 is slightly higher than before due to the weight of the plug. The unit of movement of the center of gravity is indicated as Percent Mean Aerodynamic Chord (MAC, a reference chord of the wing). The center of gravity range 70 is 30% MAC which corresponds to about a third of the average wing dimension in airflow direction. This range is a very narrow band compared to the length of the fuselage. Careful control is necessary.

The preferred size of the plug is determined by the interior space requirement that drives the desire for a plug. On a passenger aircraft, a requirement could be the addition of seat rows. Seat rows are spaced at a pitch (seating position to seating position) of between 29 and 32 inches for standard tourist class seating. The plug length would logically be set at a multiple of the desired seat pitch, such as about 60 inches to allow two additional rows. On a freighter aircraft, the pallet longitudinal size would be the determining factor. On a Boeing 757 Freighter the most common pallet pitch is 89 inches. Thus, a plug length of 89 inches would allow an existing 757 freighter to carry one additional pallet. However, shorter plugs can be useful too, because the available cabin length is never a precise multiple of the pallet pitch. This imprecision causes the aircraft to have some unused length already. Therefore, modification with a shorter plug, i.e., shorter than 89 inches, can provide an increase of interior space sufficient to accommodate an additional pallet pitch. The Boeing 757-200 Freighter can be enhanced by either method. The current maximum of fifteen 89-inch positions is achieved on this aircraft by closing the forward access doors and providing a new small crew entry door immediately behind the cockpit. The addition of the 89 inch plug would bring the maximum to sixteen positions. A significant number of the 757-200 freighter aircraft do not have this crew entry door. The requirement for access through the forward doors limits the cargo space to fourteen 89-inch positions and about 30 inches of unused space. On these aircraft, a 60-inch plug would be sufficient to increase the capacity to fifteen positions without the need for the new crew entry door. Additional multiples of the seat/pallet pitch could be added to the plug length. There is a practical limit to the single aft plug length of about 7% of the fuselage length due to: 1) the risk of tail strike; 2) the tipping risk during ground handling, and 3) a loss of directional stability in flight.

An additional factor in selecting the plug length is the standard pitch of the fuselage frames. A typical value of the frame pitch is twenty inches. While it is possible to design structure for the plug that allows a different frame pitch, this variation is undesirable because many standard parts such as windows frames and seat track are manufactured for the standard pitch. A slightly oversized plug may be preferred in order to maintain the standard frame pitch: e.g. a 100-inch plug instead of the 89 inch plug discussed above to maintain twenty inch frame spacing.

The preferred insertion point for the plug is the aft-most location of the constant section in the aft fuselage. The weight of the plug can be minimized in this location, because the applied loads decrease as the plug is moved further aft. The required strength is lower due to lower loads and the wall thickness may be reduced. However, a more forward location must be selected when the presence of access doors or miscellaneous interior items makes this location impractical. An existing circumferential splice is often the most practical location, because this location is where the fuselage sections were merged in the factory.

A preferred method turns each of these difficulties into assets to accomplish the goal of efficiently increasing interior space. The (higher) loading on the aft fuselage compared to the forward fuselage is an asset because the aft fuselage loading can be controlled, whereas the forward fuselage critical design loads cannot. A preferred method for controlling the loads is discussed in the next section. The aerodynamic interaction with the dynamic modes is an asset because the tail surfaces provide an increased modal damping when extended further aft. The complex nature of flutter analysis precludes a firm conclusion for all aircraft. Flutter is caused by the unstable combination of two vibration modes when they reach the same frequency in flight due to interaction with the airflow. For the wing, the critical modes that combine are often the first bending mode moving up in frequency and the torsion mode moving down. When the separation of these two modes is increased, it will take more aerodynamic interaction for the modes to reach the same frequency. More aerodynamic interaction requires a higher speed so there will be more safety margin. This beneficial effect on safety margin applies for example to aircraft with twin wing-mounted engines where the flutter mechanism involves fuselage vertical bending. An aft fuselage plug will create an improvement by raising the torsion mode in frequency whereas a forward fuselage plug will be potentially harmful by reducing this frequency toward the bending mode frequency.

The aft movement of the center of gravity caused by insertion of an aft plug improves aircraft fuel economy because aircraft are most efficient when loaded near the aft limit. The aft fuselage plug alleviates the reduced directional stability for operation near the aft limit by moving the tail surfaces aft. The preferred method also may take advantage of the improved effectiveness of the tail surfaces to extend the permissible aft center of gravity in the aircraft flight manual further aft. In this manner, the operator can make a more effective use of the extended aft payload space.

One preferred location for the plug is at an existing splice joint of the aircraft. The actual insertion/attachment of the fuselage plug is preferably made by standard fuselage splicing technique. One such joint splicing technique is disclosed in U.S. Pat. No. 7,325,771 hereby incorporated by reference.

A preferred method for increasing the length of the existing aircraft to increase interior space within the fuselage, may comprise the steps of installing a single extension plug section within the fuselage by (1) separating part of the aft fuselage and including the tail section from the remaining fuselage, the separation point being aft of the wing attachment; (2) joining a first end of the plug section to the separated aft fuselage with standard fuselage splicing technique; (3) attaching a second end of the extension plug section to the remaining fuselage with standard fuselage splicing technique. Steps 2 and 3 may be done in either order.

### Critical Design Load Control

The installation of a fuselage plug will increase the inertia loads on the part of the fuselage where it is installed (either forward or aft fuselage) because (1) that part of the fuselage is now heavier; and (2) the weight is held at a longer arm. In the forward fuselage, the inertia loads are the main load component for the structure located between the plug and the wing. These loads are increased and there is no means of control so a forward plug installation forces analysis and re-enforcement. The aft fuselage loads, however, are a combination of inertia loads and tail surface aerodynamic load. The preferred design preferably reduces the tail surface aerodynamic loads as necessary to compensate for the increase in aft fuselage inertia loads.

Balanced vertical maneuvers are a class of critical design condition for the aft fuselage. They are characterized by a steady load on the wing, which is balanced by opposing loads from the forward and aft fuselage. The aft fuselage load contains a component aerodynamic load from the tail to keep the aircraft balanced. When an aft fuselage plug is installed, a larger share of the reaction at the wing consists of fuselage inertia and the balancing tail load contribution can simply be reduced. Therefore, the aft fuselage plug does not change critical design loads for this type of condition forward of the plug. Aft of the plug, design loads are reduced.

For vertical design conditions that are not balanced but transient, pitching motions and aircraft flexing cause increases in load that have to be compensated by reducing the tail load. This tail load reduction can be accomplished by limiting the forward center of gravity limit. This limit is published in the aircraft flight manual along with the aft limit already mentioned in the discussion. The distance between the forward and aft limit is called the center of gravity range as explained above. A narrow range requires very precise loading of the aircraft to remain inside the limits for the duration of the flight including the effects on center of gravity of fuel burn and passenger movement. This requirement argues against restricting the forward limit. However, this preferred aircraft extension method re-balances the aircraft about a center of gravity that is further aft. As shown in FIG. 3, the existing forward limit is further away from the new fuel trace 60 than from the original fuel trace 50. This increased range allows for a greater deviation forward from the typical center of gravity for a given flight than on the original aircraft. However, there is no operational requirement for such an increase so it can be reduced back to it's nominal value as follows:. It can be seen that the forward limit 40 with forward margin 43 can be moved aft to a new forward limit 42 and a new forward margin 44. The forward margins are kept approximately the same so that the restriction will not impact operations by the need to load the aircraft more precisely. Thus, the re-balancing in combination with the simultaneous aft movement of the forward and aft limits maintains approximately the same available center of gravity range as before Thus the presence of the aft fuselage plug shifts the aircraft center of gravity in such a way that the required reduction in load may be accomplished through a forward center of gravity cut-back without operational consequences.

A final type of load condition that needs to be considered has an aerodynamic input from the tail as the dominant force. This force has not changed due to the plug. However, the arm has been increased so that bending moments forward of the plug would be increased. These loads can be controlled by reducing the control authority of the elevator and the rudder. The purpose of these control surfaces is to produce enough force to deliver a moment at the center of gravity of the required magnitude to turn the aircraft. Since the plug increases the moment arm, the required moment can now be reached with less force. Moreover, the unit force input can be reduced by an amount that is enough to keep the load forward of the plug at the level it was at prior to plug installation. The wing and the fuselage forward of the plug are unaware that they are kept in balance by a longer tail with less effort from the stabilizer with elevators in the vertical plane or the fin with rudder in the horizontal plane.

When gust loads are considered, the same reasoning is applied to the size of the tail surfaces. These surfaces need not be quite as large when placed further aft by the plug. Thus, the gust loads can be reduced. The same effect can be accomplished by manipulating the rudder and/or elevator angle to reduce peak loading.

While preferred systems and methods for extending the length of an aircraft have been shown and described, it will be apparent to one skilled in the art that modifications, alternatives and variations are possible without departing from the inventive concepts set forth herein. Therefore, the invention is intended to embrace all such modifications, alternatives and variations.

What is claimed is:

1. In an existing aircraft including a fuselage, a wing section and a tail section with horizontal and vertical surfaces, a method for increasing the length of the existing aircraft to increase interior space within the fuselage, comprising the steps of:
installing a single extension plug section within the fuselage by separating part of the aft fuselage, including the tail section, from the remaining fuselage; joining the extension plug section to the separated aft fuselage with standard fuselage splicing technique; attaching the extension plug section to the remaining fuselage with standard fuselage splicing technique.

2. A method according to claim 1 wherein the standard fuselage splicing technique does not require reinforcement of the original aircraft structure beyond the immediate attachment for the plug.

3. A method according to claim 2 further comprising modifying operating limitations of the aircraft to mitigate increases in critical design loads due to the lengthened aft fuselage, in particular a forward center of gravity range cut-back.

4. A method according to claim 3 further comprising reducing size and/or effectiveness of tail surfaces in proportion to an increased leverage arm of those surfaces relative to the center of gravity due to plug insertion to maintain equal aircraft stability and control authority.

5. A method according to claim 1 further comprising
reducing control authority of an elevator contained in the tail section to reduce vertical loads.

6. A method according to claim 5 wherein the step of reducing control authority of an elevator comprises a change in the linkage of said elevator to reduce the deflection achieved for a given control actuator input.

7. A method according to claim 1 further comprising reducing control authority of a rudder to reduce lateral loads.

8. A method according to claim 7 wherein the step of reducing control authority of a rudder comprises a change in the linkage of said rudder to reduce the deflection achieved for a given control actuator input.

9. The method of claim 1 further comprising reducing vertical loads on the aft fuselage by reducing size of the horizontal tail surface.

10. The method of claim 1 further comprising reducing lateral loads on the aft fuselage by reducing size of the vertical tail surface.

11. The method of claim 1 reducing vertical loads on the aft fuselage by active control of elevator angle.

12. The method of claim 1 reducing lateral loads on the aft fuselage by active control of rudder angle.

13. An aircraft modified from an existing aircraft, comprising
a fuselage;
a wing section;
a tail section with horizontal and vertical surfaces;
a single extension plug section inserted within the fuselage between the tail section and a position aft of the wing section, the extension plug section joined to the remaining fuselage section and the aft fuselage section via a fuselage splicing technique.
